(19) United States
(12) Patent Application Publication
(10) Pub. No.: US 2016/0196479 A1
(43) Pub. Date: Jul. 7, 2016

(54) IMAGE SIMILARITY AS A FUNCTION OF WEIGHTED DESCRIPTOR SIMILARITIES DERIVED FROM NEURAL NETWORKS

(71) Applicant: SUPERFISH LTD., Petah-Tikva (IL)

(72) Inventors: Michael CHERTOK, Raanana (IL); Alexander LORBERT, Givat Shmuel (IL)

(21) Appl. No.: 14/987,520

(22) Filed: Jan. 4, 2016

(30) Foreign Application Priority Data
Jan. 5, 2015 (IL) 236598

(51) Int. Cl. G06K 9/66; G06K 9/52; G06K 9/62

(52) U.S. Cl. CPC G06K 9/66; G06K 9/6215; G06K 9/52

(57) ABSTRACT

A method for determining image similarity as a function of weighted descriptor similarities, including the procedures of feeding a query image to a network including a plurality of layers and defining an output of each of the layers as a descriptor of the query image, feeding a reference image to the network and defining an output of each of the layers as a descriptor of the reference image, determining a descriptor similarity score for respective descriptors that were produced by the same layer of the network fed the query image and the reference image, assigning a respective weight to each descriptor similarity score and defining an image similarity between the query image and the reference image as a function of the weighted descriptor similarity scores.

### FIELD OF THE DISCLOSED TECHNIQUE

The disclosed technique relates to image similarity in general, and to methods and systems for determining image similarity as a function of a plurality of weighted descriptor similarities, where the image descriptors are produced by applying convolutional neural networks on the images, in particular.

### BACKGROUND OF THE DISCLOSED TECHNIQUE

For many visual tasks, the manner in which the image is represented can have a substantial effect on both the performance and the results of the visual task. Convolutional neural networks (CNN) are known in the art. These artificial networks of neurons can be trained by a training set of images and thereafter be employed for producing representations of an input image. The artificial networks can either be trained in an unsupervised manner (i.e., no labels at all), or in a supervised manner (e.g., receiving labels of either classes of images; receiving similar/not-similar pairs of images; or receiving triplets of: query image, r+ (a reference more similar to q than r−), and r− (a reference less similar to q than r+)).

An article by Krizhevsky et al., entitled “ImageNet Classification with Deep Convolutional Neural Networks” published in the proceedings from the conference on Neural Information Processing Systems 2012, describes the architecture and operation of a deep convolutional neural network. The CNN of this publication includes eight learned layers (five convolutional layers and three fully-connected layers). The pooling layers in this publication include overlapping tiles covering their respective input in an overlapping manner. The detailed CNN is employed for image classification.

An article by Zeiler et al., entitled “Visualizing and Understanding Convolutional Networks” published on http://arxiv.org/abs/1311.2901v3, is directed to a visualization technique that gives insight into the function of intermediate feature layers of a CNN. The visualization technique shows a plausible and interpretable input pattern (situated in the original input image space) that gives rise to a given activation in the feature maps. The visualization technique employs a multi-layered de-convolutional network. A de-convolutional network employs the same components as a convolutional network (e.g., filtering and pooling) but in reverse. Thus, this article describes mapping detected features in the produced feature maps to the image space of the input image. In this article, the de-convolutional networks are employed as a probe of an already trained convolutional network.

### SUMMARY OF THE DISCLOSED TECHNIQUE

The disclosed technique overcomes the disadvantages of the prior art by providing a method for determining image similarity as a function of weighted descriptor similarities. The method includes the procedures of feeding a query image to a network, the network including a plurality of layers, and defining an output of each of the layers as a descriptor of the query image. The method also includes the procedures of feeding a reference image to the network and defining an output of each of the layers as a descriptor of the reference image and determining a descriptor similarity score for respective descriptors that were produced by the same layer of the network fed the query image and the reference image. The method further includes the procedures of assigning a respective weight to each descriptor similarity score and defining an image similarity between the query image and the reference image as a function of the weighted descriptor similarity scores.

According to another aspect of the disclosed technique there is thus provided a method for determining image similarity as function of weighted descriptor similarities. The method includes the procedures of defining a plurality of descriptors for a query image and defining the plurality of descriptors for a reference image. The method also includes the procedures of determining for each selected descriptor of the plurality of descriptors a descriptor similarity score for the selected descriptor of the query image and the selected descriptor of the reference image, and assigning a weight to each descriptor similarity score. The method further includes the procedure of defining an image similarity between the query image and the reference image as a function of weighted descriptor similarity scores.

### BRIEF DESCRIPTION OF THE DRAWINGS

The disclosed technique will be understood and appreciated more fully from the following detailed description taken in conjunction with the drawings in which:

FIGS. 1A and 1B, are schematic illustrations of a convolutional neural network, constructed and operative in accordance with an embodiment of the disclosed technique;

FIG. 2 is a schematic illustration of a method for determining the weights of image descriptor similarities for fusing the descriptor similarities for determining image similarity between a pair of images, operative in accordance with another embodiment of the disclosed technique;

FIG. 3 is a schematic illustration of a method for determining image similarity as a function of descriptor similarities, operative in accordance with a further embodiment of the disclosed technique; and

FIG. 4 is a schematic illustration of a system for determining image similarity as a function of descriptor similarities, constructed and operative in accordance with another embodiment of the disclosed technique.

### DETAILED DESCRIPTION OF THE EMBODIMENTS

The disclosed technique overcomes the disadvantages of the prior art by providing a method and a system for determining image similarity between a pair of images (e.g., a query image and a reference image) as a function of weighted descriptor similarities. Generally, a set of descriptors is defined for the query image and for the reference image. The similarity between respective descriptors of the query image and of the reference image is determined. The descriptor similarities are assigned with weights. The image similarity is determined as a function of the weighted descriptor similarities.

In accordance with an embodiment of the disclosed technique, the image descriptors are produced at the output of the layers of an artificial neural network (e.g., a Convolutional Neural Network—CNN) when applying the network on each of the images. In particular, the output of each layer of the network serves as a descriptor for the image on which the network is applied. That is, when applying the network on the query image, the output of each layer serves as a descriptor for the query image, thereby producing a plurality of descriptors (numbering as the number of layers of the network) for the query image. It is noted that for a convolutional network, the convolutional layers produce a three dimensional output matrix and the fully connected layers produce a vector output. In accordance with another embodiment of the disclosed technique, several networks are applied onto the images, and the output of layers of different networks are defined as descriptors. The descriptors are employed together for determining image similarity. Corresponding descriptors of the query image and of the reference image are compared and the descriptor similarity (or distance) between them is determined. That is, the similarity between the output of the first layer for the query image (i.e., the first descriptor of the query image) and the output of the first layer for the reference image (i.e., the first descriptor of the reference image), is determined. Likewise, the descriptor similarity between the second descriptor of query image and the second descriptor of the reference image is determined, and so forth for the other descriptors (i.e., produced by the other layers of the network, and possibly by layers of other networks).

Each determined descriptor similarity score, for each of the descriptors, is assigned a respective weight. The image similarity score between the query image and the reference image is given by the sum of weighted descriptor similarities. Alternatively, the image similarity score between the images can be given by another function of the weighted descriptor similarities (e.g., a non-linear function).

The weights of the descriptors are assigned by applying the network on images of a weight-assigning set of images, which similarity (or distance) is known. In particular, the similarity between a plurality of pairs of images of the weight-assigning set is known, or is predetermined. The images of the weight-assigning set are run through the network, and the output of each layer is recorded as a descriptor for the respective image. That is, for an image ‘i’ a set of descriptors (Dⁱ₁, Dⁱ₂, . . . , Dⁱ_{L}) is produced. Where, Dⁱ_{L} is the descriptor produced for at the output of layer ‘L’, when applying the network on image ‘i’.

The weights assigned to each descriptor (i.e., layer output) are determined as follows. For a pair of images, which similarity is known (i.e., as defined by a human evaluator), the descriptor similarity (or distance) between descriptors produced by the same layer, is determined. That is, the descriptor similarity between Dⁱ_{L} and D^{j}_{L} is determined, for each layer of the network applied on images ‘i’ and ‘j’. The similarity between descriptors is determined as known in the art. For example, for vector descriptors (as produced by fully connected layers) the similarity can be given by the inner product of the vector descriptors. In the same manner, for other pairs of images which image similarity is known, the descriptor similarities between pairs of respective descriptors (i.e., produced by the same layer) are determined. Thereby, for each pair of images ‘i’ and ‘j’, which image similarity is known, the following equation is defined:

α₁S₁+α₂S₂+ . . . +αₖSₖ=imageSimilarityScore [1]

Where S₁ is the determined descriptor similarity score between descriptors Dⁱ₁ and D^{j}₁, and α₁ is the weight to be assigned (i.e., a variable) to that descriptor similarity score. The weights α₁, α₂, . . . , αₖ are determined according to the plurality of equations [1] defined for pairs of images, which image similarity is known. For example, the weights α₁, α₂, . . . , αₖ can be determined by regression. In accordance with another embodiment of the disclosed technique, more than a single network can be applied on each image, such that each image is associated with a set of descriptors produced at the output of layers of several networks—(DⁱN₁L₁, . . . , DⁱN₁Lₖ, DⁱN₂L₁, . . . , DⁱN₂L_{L}, DⁱN_{N}L₁, . . . , DⁱN_{N}L_{M}). Where, DⁱN_{N}L_{L}, is a descriptor produced at the output of layer ‘L’ when applying a network ‘N’ on an image ‘i’.

In accordance with yet another embodiment, only the descriptors of selected layers are employed for image representation and for similarity determination. For example, only the layers which respective weights exceed a threshold, or only layers that were assigned the top five weights are employed for image representation. Thereby, the image representation and similarity determination require less computational resources while maintaining adequate results.

In accordance with yet another embodiment of the disclosed technique, a descriptor can include a plurality of elements (either grouped together to form the descriptor or serving as independent descriptors by themselves). For example, a descriptor defined by the output of a convolutional layer can include a plurality of elements composed by the output of each of the filters of the convolutional network. In this embodiment, a descriptor-element similarity (i.e., an element similarity) is determined for respective descriptor elements of the pairs of images. Additionally, a weight is assigned to each element similarity. Thus, a descriptor similarity would be given as a vector (i.e., a set of element similarities) instead of a scalar (i.e., a single value). Alternatively, descriptor elements can be treated as independent descriptors.

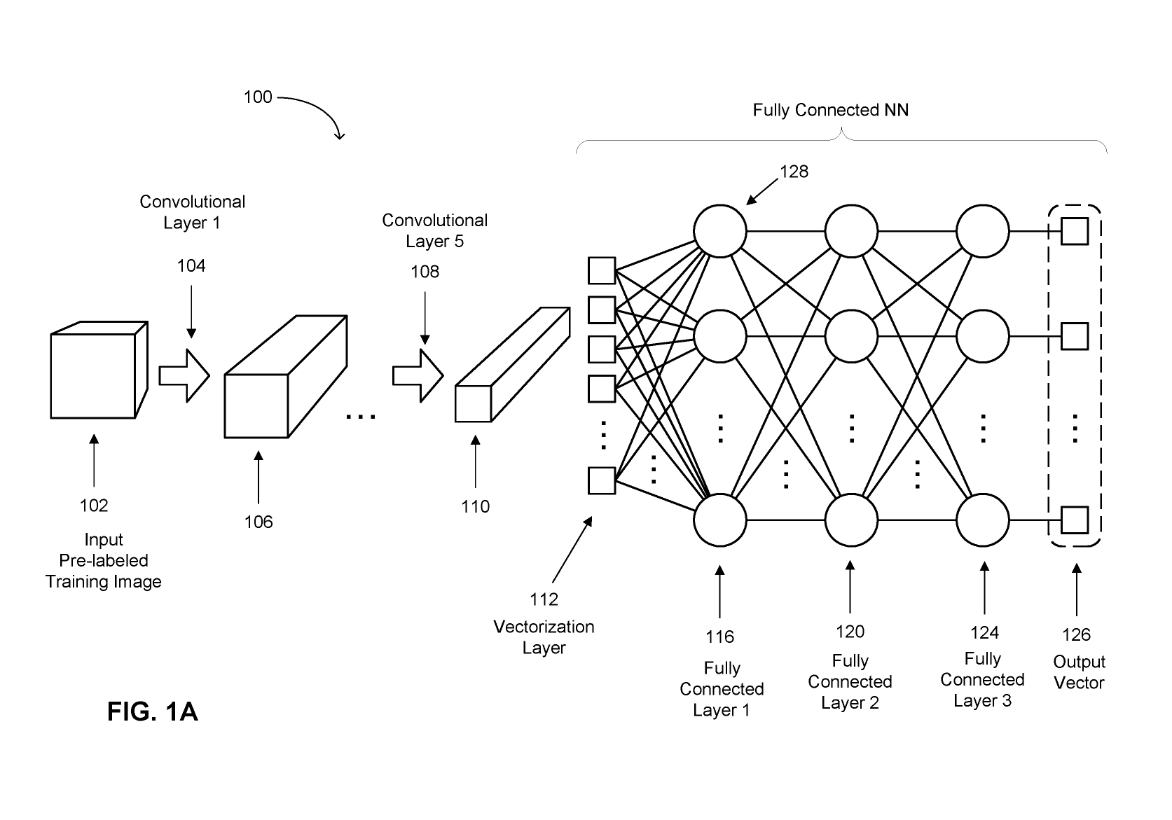

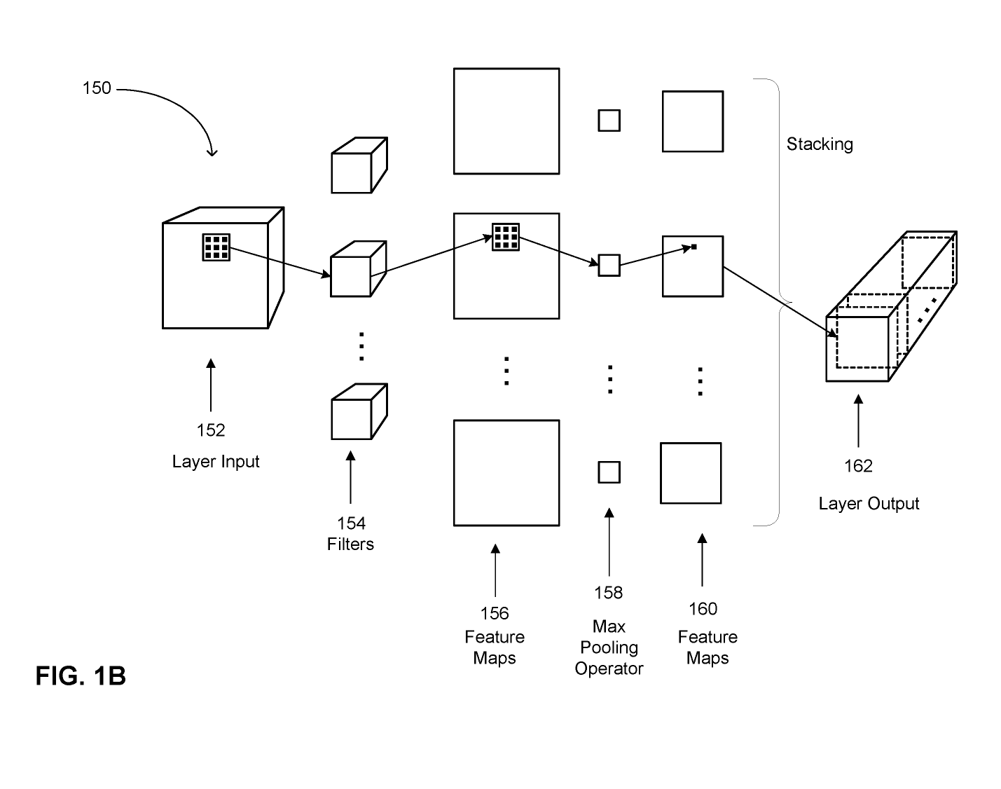

As mentioned above, for reducing computational costs only selected descriptors of selected layers (and only selected elements of a selected descriptor) are employed for determining image similarity. Put another way, the weight assigned to some descriptor similarities, or element similarities, can be zero. For example, each descriptor similarity which weight does not exceed a threshold is zeroed. Another example, is using only the top X similarities, which were assigned with the highest weights, and zeroing all other descriptor similarities. Reference is now made to FIGS. 1A and 1B, which are schematic illustrations of a Convolutional Neural Network (CNN), generally referenced 100, constructed and operative in accordance with an embodiment of the disclosed technique. FIG. 1A depicts an overview of CNN 100. FIG. 1B depicts a selected convolutional layer of CNN 100. With reference to FIG. 1A, CNN 100 includes five convolutional layers of which only the first and the fifth are shown and are denoted as 104 and 108, respectively, and having respective outputs 106 and 110. It is noted that CNN 100 can include more, or less, convolutional layers. The output of fifth convolutional layer 110 is vectorized in vectorizing layer 112, and the vector output is fed into a layered, fully connected, neural network (not referenced). In the example set forth in FIG. 1A, in the fully connected neural network of CNN 100 there are three fully connected layers 116, 120 and 124—more, or less, layers are possible (including even zero—no fully connect layers at all). An input image 102 is fed into CNN 100 as a 3D matrix.

Each of fully connected layers 116, 120 and 124 comprises a variable number of linear, or affine, operators 128 (neurons) potentially followed by a nonlinear activation function. As indicated by its name, each of the neurons of a fully connected layer is connected to each of the neurons of the preceding fully connected layer, and is similarly connected with each of the neurons of a subsequent fully connected layer. Each layer of the fully connected network receives an input vector of values assigned to its neurons and produces an output vector (i.e., assigned to the neurons of the next layer, or outputted as the network output by the last layer). The last fully connected layer 124 is typically a normalization layer so that the final elements of an output vector 126 are bounded in some fixed, interpretable range. For example, the normalization layer can be a probability layer normalizing the output vector such that sum of all values is one. The parameters of each convolutional layer and each fully connected layer are set during a training (i.e., learning) period of CNN 100. Specifically, CNN 100 is trained by applying it to a training set of pre-labeled images 102.

The structure and operation of each of the convolutional layers is further detailed in the following paragraphs. With reference to FIG. 1B, the input to each convolutional layer is a multichannel feature map 152 (i.e., a three-dimensional—3D—matrix). For example, the input to first convolutional layer 106 (FIG. 1A) is an input image 152 represented as a multichannel feature map. Thus, for instance, a color input image may contain the various color intensity channels. The depth dimension of multichannel feature map 152 is defined by its channels. That is, for an input image having three color channels, the multichannel feature map would be an X×Y×3 matrix (i.e., the depth dimension has a value of three). The horizontal ‘X’ and vertical ‘Y’ dimensions of multichannel feature map 152 (i.e., the width and height of matrix 152) are defined by the respective dimensions of the input image. The input to subsequent layers is a stack of the features maps of the preceding layer arranged as 3D matrix.

Input multichannel feature map 152 is convolved with filters 154 that are set in the training stage of CNN 100. While each of filters 154 has the same depth as input feature map 152, the horizontal and vertical dimensions of the filter may vary. Each of the filters 154 is convolved with the layer input 152 to generate a feature map 156 represented as a two-dimensional (2D) matrix.

Subsequently, an optional max pooling operator 158 is applied on feature maps 156 for producing feature maps 160. Max-pooling layer 158 reduces the computational cost for deeper layers (i.e., max pooling layer 158 serves as a sub-sampling or down-sampling layer). Both convolution and max pooling operations contain various strides (or incremental steps) by which the respective input is horizontally and vertically traversed. Lastly, 2D feature maps 160 are stacked to yield a 3D output matrix 162.

It is noted that a convolution layer can be augmented with rectified linear operation and a max pooling layer 158 can be augmented with normalization (e.g., local response normalization—as described, for example, in the Krizhevsky article referenced in the background section herein above). Alternatively, max pooling layer 158 can be replaced by another feature-pooling layer, such as average pooling layer, a quantile pooling layer, or rank pooling layer.

In the example set forth in FIGS. 1A and 1B, CNN 100 includes five convolutional layers. However, the disclosed technique can be implemented by employing CNNs having more, or less, layers (e.g., three convolutional layers). Moreover, other parameters and characteristics of the CNN can be adapted according to the specific task, available resources, user preferences, the training set, the input image, and the like. Additionally, the disclosed technique is also applicable to other types of artificial neural networks (besides CNNs).

In accordance with an embodiment of the disclosed technique, the output of each layer of CNN 100 is recorded. It is noted that the output of the convolutional layers is a 3D matrix and the output of the fully connected layers is a vector. The output of each layer serves as a descriptor for input image 102. Thereby, input image 102 is associated with a set of descriptors produced at the output of the layers of CNN 100. In the example set forth in FIG. 1A, CNN 100 has five convolutional layers and three fully connected layers, and thus, image 102 is associated with eight descriptors: (Dⁱ₁, Dⁱ₂, Dⁱ₃, Dⁱ₄, Dⁱ₅ Dⁱ₆, Dⁱ₇, Dⁱ₈).

In accordance with another embodiment of the disclosed technique, each 2D feature map produced by a filter of a convolutional layer is defined as a descriptor element, of the descriptor defined as the 3D stack of the 2D maps. Alternatively, each 2D feature map can be defined as a descriptor by itself. Thereby, at the output of each convolutional layer a plurality of descriptors (numbering as the number of filters of the convolutional layer) are produced. In accordance with an alternative embodiment of the disclosed technique, the output matrices produced by the convolutional layers can be vectorized, thereby all descriptors of input image 102 are vectors.

As mentioned above, input image 102 can be represented by a set of descriptors produced by the layers of the convolutional network. Image similarity between a query image and a reference image is determined as a function of the weighted descriptor similarities (i.e., similarities between descriptors produced by the same layer). For example, the similarity is determined as a sum of the weighted descriptor similarities. The following paragraphs detail the assignment of the weights to the different layers.

For determining the weights, the network is applied on a weight-assigning set of images. The weight-assigning set of images includes images for which a similarity score between at least some pairs of images is known. For example, the similarity score (or distance score) is predetermined by human users, or by a similarity determination algorithm as known in the art.

The network is applied on each image of a pair of images (i,j), which similarity is known. Each image is associated with a set of descriptors. For example, image ‘i’ is associated with a set of descriptors (Dⁱ₁, Dⁱ₂, . . . , Dⁱ_{L}), and image ‘j’ is associated with a set of descriptors (D^{j}₁, D^{j}₂, . . . , D^{j}_{L}), where Dⁱ_{L} is a descriptors produced by layer L of the convolutional network when applied on image ‘i’.

The descriptor similarity (or distance) between corresponding descriptors, produced by the same layer, is determined. For example, the similarity between Dⁱ₁ and D^{j}₁ is determined. In the same manner, the similarity between the descriptors of all layers of the network is determined. The similarity between descriptors can be determined, for example, by inner product for vector descriptors, or by other operators as known in the art. Alternatively, the distance (e.g., the Euclidean distance) between the descriptors is determined instead of the similarity.

In the same manner, the descriptor similarity between descriptors of other pairs of images is determined. As mentioned above, the image similarity between each of these pairs of images is known, or is predetermined. Thereby, equation [1] herein can be drafted for each such pair of images:

α₁S₁+α₂S₂+ . . . +αₖSₖ=imageSimilarityScore [1]

Where S₁ is the determined similarity between the descriptors produced by the first layer (Dⁱ₁ and D^{j}₁), S₂ is the determined similarity between the descriptors produced by the second layer (Dⁱ₂ and D^{j}₂), and so forth. α₁ is the weight to be assigned (i.e., a variable) to the descriptor similarity between descriptors Dⁱ₁ and D^{j}₁ (S₁).

Next, the weights α₁, α₂, . . . , αₖ are determined according to the plurality of equations [1] defined for pairs of images, which image similarity is known. For example, the weights α₁, α₂, . . . , αₖ can be determined by regression, or by other methods or algorithms as known in the art.

In the embodiments detailed herein above, the weights of the descriptor similarities are similar for all query images (i.e., the weights are independent of the query image). In accordance with another embodiment of the disclosed technique, the weights are query-dependent. That is, the weights assigned to each descriptor similarity are a function of the query image (or a function of some characteristic of the query image).

For example, this function can be learned by selecting a subset of the weight-setting set of images for each query. The similarity of a selected query image with each image of the selected weight-assigning subset of images is known (or predetermined). Thus, per-query weights (i.e., query-dependent weights) can be learned. Alternatively, a nearest-neighbor image is determined for the selected query image out of the weight-assigning set and the weights of this nearest-neighbor image are employed for determining the query-dependent weights in a similar manner to that described above.

In accordance with a further embodiment, once the query dependent weights have been determined for a selected query, a weight-assigning function, mapping the query image to the learned query-dependent weights, can be learned. In this manner, a plurality of queries and respective query-dependent weight sets, can be employed as a training set for training the weight-assigning function. After training, the weight-assigning function receives a new query image, and produces the weights of the descriptor similarities according to the new query image, circumventing the weigh assigning procedure requiring the weight-assigning image set. Thus, the weight-assigning function (that maps a selected query to a set of descriptor similarities weights) can be learned in conjunction with, or subsequent to, learning query-dependent weights

As mentioned above, the weights can be assigned to the elements of each descriptor, such that each descriptor is associated with a weight vector (instead of a weight scalar). The descriptor elements can be, for example, the different filters of a convolutional layer. The convolutional layer includes a plurality of filters, each producing a feature map by convolution with the layer input. The feature maps of all the filters are stacked together to give the output of the layer. Each feature map (the output of convolution of each filter) can be assigned its own weight, thereby the descriptor represented by the output of the convolutional layer is associated with a set, or vector, of weights.

The network is applied on each image of a pair of images (i,j), which similarity is known. Each image is associated with a set of descriptors, each including a set of elements. For example, image ‘i’ is associated with a set of descriptor elements (Dⁱ₁₁, Dⁱ₁₂, . . . Dⁱ₂₁, Dⁱ₂₂, . . . , Dⁱ_{LK}), where Dⁱⱼₖ is an element ‘k’ of descriptor ‘j’, produced by filter ‘k’ of layer ‘j’ when applied on image ‘i’.

Thus, in the case that the descriptor weights are vectors, the terms α₁ and S₁ in equation [1] are vectors and not scalars, giving equation [2]:

α₁₁S₁₁+α₁₂S₁₂+ . . . α₂₁S₂₁+α₂₂S₂₂+ . . . +αₖ₁Sₖ₁+αₖⱼSₖ₁ⱼ=imageSimilarityScore [2]

Where S₁₁ is the determined descriptor-element similarity score between the first element of the first descriptor, and α₁₁ is the weight (i.e., a variable) to be assigned to that descriptor-element similarity score. The weights α₁₁, α₁₂, . . . α₂₁, α₂₂, . . . , αₖ₁, . . . α_{KL} are determined according to the plurality of equations [2] defined for pairs of images, which image similarity is known.

The descriptor similarity weights α₁, α₂, . . . , αₖ (either scalar or vector) are thereafter employed for determining image similarity between two images (e.g., a query image and a reference image), each represented by a descriptors set. In particular, a convolutional network is applied on the query image, and the descriptors at the output of the layers of the network are recorded. That is, a query image ‘i’ is represented as (Dⁱ₁, Dⁱ₂, . . . , Dⁱ_{K}), where Dⁱ₁ is the descriptor produced by the first layer, Dⁱ₂ is the descriptor produced by the second layer, and so forth until Dⁱ_{K} that is the descriptor produced by the last layer—the K^{th} layer. Likewise, a reference image ‘j’ is represented as (D^{j}₁, D^{j}₂, . . . , D^{j}_{K}). Thereafter, the descriptor similarity for each pair of respective descriptors (i.e., descriptors produced by the same layer) is determined. That is the descriptor similarity between Dⁱ₁ and D^{j}₁ (herein denoted as S₁), and so forth. Each descriptor similarity is assigned a respective weight according to the determined weights α₁, α₂, . . . , αₖ. Lastly, the image similarity is given as a function of the weighted descriptor similarities: imageSimilarity=F(α₁S₁,α₂S₂, . . . ,α_{K}S_{K}). For example, the image similarity is given as the sum of weighted descriptor similarities: imageSimilarity=α₁S₁+α₂S₂+ . . . +α_{K}S_{K}.

In accordance with another embodiment of the disclosed technique, more than a single network can be applied on the images. Thereafter, the descriptors produced at the output of the layers of the applied networks are assigned a weight is a similar manner. For example, two networks are applied on each image. First, the networks are applied on the images of the weight-assigning set. Each image is associated with a set of descriptors (DⁱN₁L₁, DⁱN₁L₂ . . . , DⁱN₁L_{K} . . . , DⁱN₂L₁, DⁱN₂L₂ . . . , DⁱN₂L_{L}), where DⁱN_{N}L_{L} is a descriptor assigned to image ‘i’ by layer L of network N. Then, for pairs of images, which image similarity is known, the respective descriptors are compared (i.e., the similarity between descriptors produced by the same layer of the same network is determined). The weights of each layer of each network are determined, for example by regression, according to the sets of descriptor similarities and respective image similarities as detailed herein above.

After the weights are assigned to each layer, a new input image is represented as a set of descriptors (DⁱN₁L₁, DⁱN₁ L₂ . . . , DⁱN₁ L_{K} . . . , DⁱN₂L₁, DⁱN₂L₂ . . . , DⁱN₂L_{L}). The similarity between the input image and a reference image is given by the sum of weighted descriptor similarities:

imageSimilarity=α₁₁Similarity(DⁱN₁L₁,D^{j}N₁L₁)+α₁₂Similarity(DⁱN₁L₂,DⁱN₁L₂+ . . . +α_{NL}Similarity(DⁱN_{N}L_{L},D^{j}N_{N}L_{L}))

Where, Similarity(DⁱN_{N}L_{L},DⁱN_{N}L_{L}) is the descriptor similarity score between respective descriptors of the images ‘i’ and ‘j’ produced by layer ‘L’ of network ‘N’. α_{NL} is the weight assigned to layer ‘L’ of network ‘N’ (i.e., to the descriptor similarity of that layer).

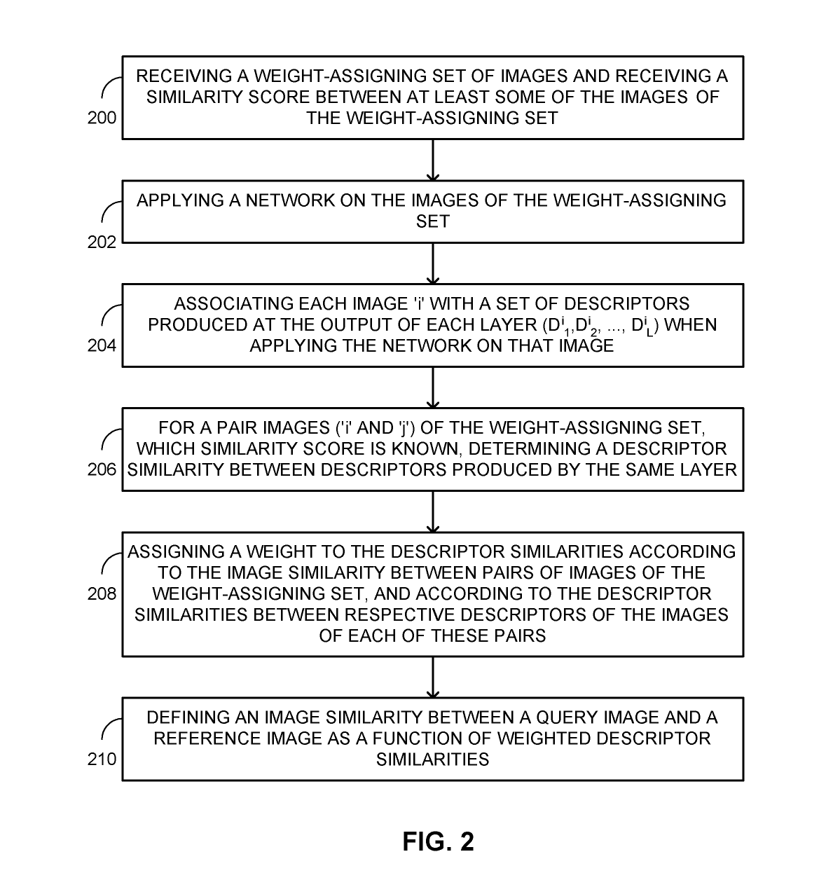

Reference is now made to FIG. 2, which is a schematic illustration of a method for assigning weights to image descriptor similarities for determining image similarity between a pair of images, operative in accordance with another embodiment of the disclosed technique.

In procedure 200, a weight-assigning set of images is received.

A similarity score between pairs of images of the weight-assigning set is known. Alternatively, the similarity score between pairs of images is determined and recorded, for example, by human users or by a similarity (or distance) algorithms as known in the art.

In procedure 202, a network (e.g., a convolutional neural network) is applied on the images of the weigh-assigning set. Each image undergoes the same (or similar) preprocessing, which was applied to every other image when training the neural network. The output of the layers of the network, when applied on an image, is recorded. With reference to FIG. 1A, CNN 100 is applied on the images of the weight-assigning set.

In procedure 204, each image ‘i’ is associated with a set of image descriptors produced at the output of each layer, when applying the network on that image, (Dⁱ₁, Dⁱ₂, . . . , Dⁱ_{L}). Where, Dⁱ_{L} is the descriptor produced at the output of layer ‘L’ when the network is applied on image ‘i’. That is, the output of each layer of the network is defined as an image descriptor for the image on which the network is applied. With reference to FIGS. 1A and 1B, input image 102 is associated with a descriptor set composed of the descriptors produced at the output of convolutional layers 104-108, and fully connected layers 116, 120 and 124. It is noted that the output of the convolutional layers is a 3D matrix, and the output of the fully connected layers is a vector. In accordance with an alternative embodiment of the disclosed technique, the output matrices can be vectorized to generate a set of vector descriptors.

In procedure 206, for a pair images (‘i’ and ‘j’) of the weight-assigning set, which similarity score is known, a descriptor similarity is determined between respective descriptors that were produced by the same layer. Thus, each image is associated with a set of descriptors. The similarity (or distance) between the descriptor of image ‘i’ produced by layer 1—Dⁱ₁—and the descriptor of image ‘j’ produced by layer 1—D^{j}₁—is determined. The descriptor similarity is determined as known in the art, for example, by the inner product for vector descriptors. In the same manner, the similarity between every other pair of respective descriptors is determined. In particular, the similarity between Dⁱ₂ and D^{j}₂, between Dⁱ₃ and D^{j}₃, and so forth until Dⁱ_{K} and D^{j}_{K}, for a network having ‘K’ layers. These descriptor similarities can be denoted as S₁, S₂, . . . , S_{K}. Likewise, sets of descriptor similarities between descriptors of other pairs of images (for which the image similarity is known) are determined.

In procedure 208, a weight is assigned to the descriptor similarities. The weight is assigned according to the image similarity between pairs of images of the weight-assigning set, and according to the descriptor similarities between respective descriptors of the images of each of these pairs. As detailed herein above with reference to procedure 206, each image is associated with a descriptor set. Additionally, descriptor similarity between respective descriptors for a pair of images is determined. Thereby, for each pair of images, for which the image similarity is known, a set of descriptor similarities is determined. Accordingly, equation [1] can be drafted for each pair of images of the weight-assigning set:

α₁S₁+α₂S₂+ . . . +αₖSₖ=imageSimilarityScore [1]

Where S₁ is the determined similarity between the descriptors produced by the first layer (Dⁱ₁ and D^{j}₁), S₂ is the determined similarity between the descriptors produced by the second layer (Dⁱ₂ and D^{j}₂), and so forth. α₁ is the weight to be assigned (i.e., a variable) to the descriptor similarity between descriptors Dⁱ₁ and D^{j}₁ (S₁). From the plurality of equations [1] defined for the plurality of pairs of the weigh-assigning set, the weights for each layer output can be determined, for example, by regression.

In accordance with another embodiment of the disclosed technique, equation [1] which gives the weighted sum of descriptor similarities can be replaced by any other weighted function:

f(α₁S₁,α₂S₂, . . . ,αₖSₖ)=imageSimilarityScore [3]

In accordance with yet another embodiment of the disclosed technique, each descriptor includes a plurality of descriptor elements. For example, a descriptor given by the output of a convolutional layer includes a plurality of 2D feature maps given by the filters of the convolutional layer. That is, the 2D feature maps are the elements, and the stacked 3D feature map is the descriptor. In this embodiment, a similarity score is determined for each respective pair of descriptor elements. For example, the similarity between the output of a selected filter of a selected convolutional layer for image ‘i’ and for image ‘j’. The descriptor similarity is given by the set of descriptor-elements similarities. In other words, the descriptor similarity is a vector (i.e., a set of values) instead of a scalar (i.e., a single value).

In accordance with yet another embodiment of the disclosed technique, more than a single network can be applied on the images for producing descriptors. The weight of each descriptor similarity is determined in a similar manner, according to the predetermined image similarities.

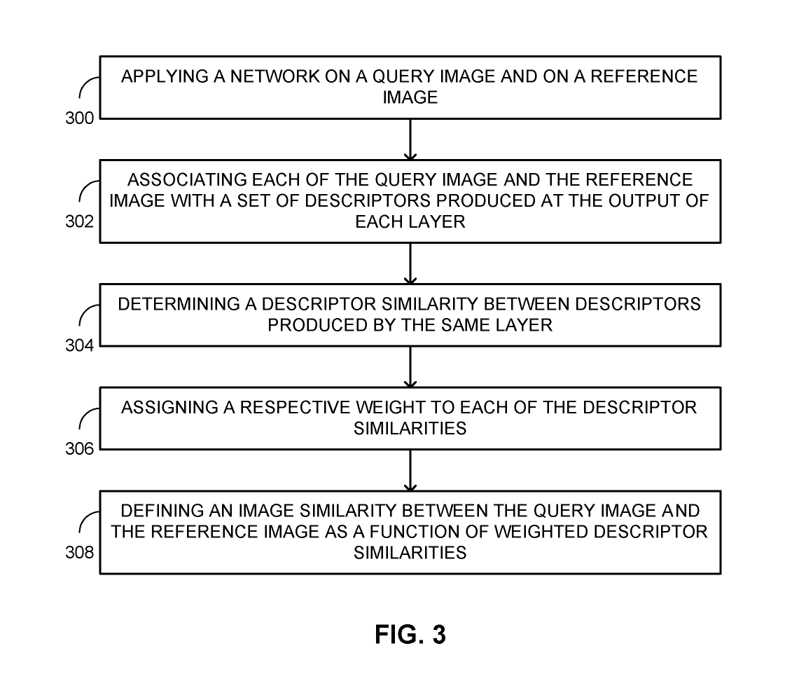

In procedure 210, an image similarity between a query image and a reference image is defined as a function of weighted descriptor similarities. The image similarity determination method is elaborated further herein below with reference to FIG. 3. In a nutshell, each of the query image and the reference image is associated with a set of descriptors. The descriptor similarities between respective descriptors are determined and are assigned with weights. The weights are determined (learned) as detailed herein above. The image similarity is defined as a function (e.g., a sum) of the weighted descriptor similarities.

As mentioned above, for reducing computational costs only selected descriptors of selected layers (and only selected elements of a selected descriptor) are employed for determining image similarity. Put another way, the weight assigned to some descriptor similarities, or element similarities, can be zero. For example, each descriptor similarity which weight does not exceed a threshold is zeroed. Another example, is using only the top X similarities, which were assigned with the highest weights, and zeroing all other descriptor similarities. For instance, let us assume that two networks are applied on a query image and on a reference image. Each network includes five layers. Thereby ten descriptors are produced (i.e., one by each layer of the applied networks). Let us further assume that each of the descriptors includes a plurality of elements. The image similarity can be determined according to two elements of the first descriptor of the first network, the third descriptor of the first network, and the fourth and fifth descriptors of the second network, in case all other descriptor, or element similarities, did not exceed a predetermined threshold. Reference is now made to FIG. 3, which is a schematic illustration of a method for determining image similarity as function of weighted descriptor similarities, operative in accordance with a further embodiment of the disclosed technique. In procedure 300, a network is applied on a query image and on a reference image. With reference to FIG. 1A, CNN 100 is applied on a reference image and on a reference image.

In procedure 302, each of the query image and the reference image is associated with a set of descriptors produced at the output of selected layers of the network. For example, the output of a selected layer is defined as an image descriptor for the image on which the network is applied. In accordance with another embodiment, only selected elements of the output of a selected layer are defined as elements of the image descriptor (or as separate image descriptors). The layers (or layer elements) selected for producing descriptors are selected according to the weights assigned to the descriptors produced at the output of the layers of the network, as detailed herein above with reference to procedures 208 and 210 of FIG. 2. In accordance with yet another embodiment, more than a single network is applied on the query image and on the reference image for defining descriptors for the images.

Each of the images is thereby associated with a set of descriptors, which can be produced by a plurality of networks, and which can include a plurality of descriptor elements. With reference to FIG. 1A, the reference image ‘i’ is associated with a set of descriptors (Dⁱ₁, Dⁱ₂, Dⁱ₃, Dⁱ₄, Dⁱ₅, Dⁱ₆, Dⁱ₇, Dⁱ₈), and the query image is associated with a set of descriptors (D^{j}₁, D^{j}₂, D^{j}₃, D^{j}₄, D^{j}₅, D^{j}₆, D^{j}₇, D^{j}₈). It is noted that as CNN 100 includes eight layers (i.e., five convolutional layers and three fully connected layers), each of the images is associated with eight image descriptors. Alternatively, only some of the descriptors can be used for reducing the computational resources required.

In procedure 304, a descriptor similarity is determined between descriptors produced by the same layer. That is, the similarity between Dⁱ₁ and D^{j}₁, the similarity between Dⁱ₂ and D^{j}₂, and so forth. Herein the descriptor similarities are also denoted as: S₁=similarity(Dⁱ₁,D^{j}₁). Thereby, a set of descriptor similarities is defined (S₁, S₂, . . . , S_{K}). As mentioned above, in case descriptor includes a plurality of elements, an element similarity is determined for each descriptor element, and the descriptor similarity is a set of the descriptor elements similarities. Alternatively, each element can be considered as an independent descriptor, such that the element similarity is considered as a descriptor similarity.

In procedure 306, a respective weight is assigned to each of the descriptor similarities. The respective weight assigned to descriptor similarity is determined as detailed herein above with reference to FIG. 2. Descriptors, or descriptor elements, which determined weight as determined in procedure 208 of FIG. 2 is below a threshold, can be omitted for reducing computation costs. That is, the selected layers, or layer elements, which output is defined as a descriptor, or descriptor element, are those which determined weight exceeds the threshold.

In procedure 308, an image similarity between the query image and the reference image is defined as a function of weighted descriptor similarities: imageSimidrity=F(α₁S₁,α₂S₂, . . . ,α_{K}S_{K}). For example, the image similarity is given as the sum of weighted descriptor similarities: imageSimilarity=α₁S₁+α₂S₂+ . . . +α_{K}S_{K}.

In the examples set forth herein above, in FIGS. 2 and 3, a single network was applied on each image. In accordance with an alternative embodiment of the disclosed technique, a plurality of networks can be applied on each image, each producing at least one image descriptor. The weights to the different layers of the different networks are assigned in a similar manner to that described above (FIG. 2). Thereafter, image similarity between a pair of images is given by a function of weighted descriptor similarities as described above (FIG. 3).

In accordance with another embodiment of the disclosed technique, layers which receive a small weight (i.e., not exceeding a predetermined threshold) can be removed from the weighted descriptor similarities function. Thereby, the computational resources required for image similarity determination are reduced. For example, only the descriptor similarities which were assigned the top five weights are summed (or otherwise fused for determining image similarity). These descriptors are produced by five layers, which can all belong to a single network, or can belong to several networks.

In accordance with yet another embodiment of the disclosed technique, the method for assigning weights to descriptor similarities for fusing the descriptor similarities (FIG. 2), and the method for determining image similarity as a function of the weighted descriptor similarities (FIG. 3) can be applied to every set of image descriptors, whether produced by a convolutional network, another network, or by any other method for producing image descriptors as known in the art. Specifically, descriptor similarities for respective descriptors for a plurality of image pairs, which image similarity is known, are determined. A weight is assigned to each descriptor similarity by, for example, regression. Thereafter, a query image and a reference image are each represented as a set of the descriptors. The descriptor similarities for respective descriptors of the query and the reference image are determined. Lastly, the image similarity is defined as a function of the weighted descriptor similarities.

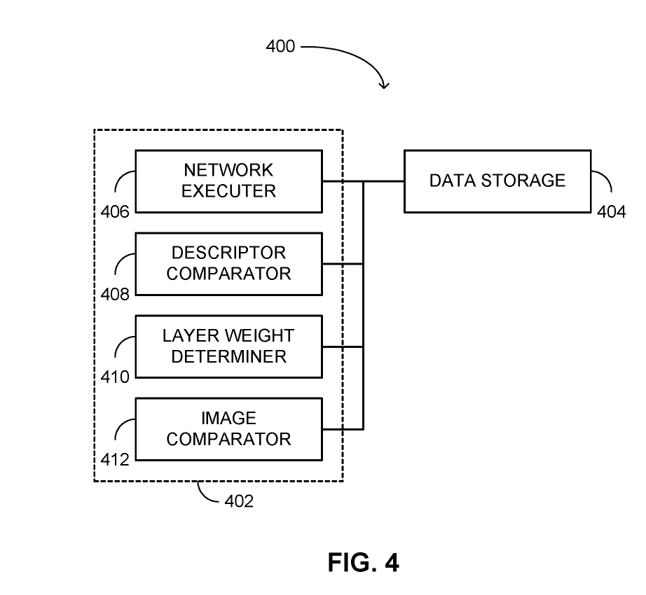

Reference is now made to FIG. 4, which is a schematic illustration of a system, generally referenced 400, for determining image similarity as a function of descriptor similarities, constructed and operative in accordance with another embodiment of the disclosed technique. System 400 includes a processing system 402 and a data storage 404. Processing system 402 includes a plurality of modules. In the example set forth in FIG. 4, processing system 402 includes a network executer 406, a descriptor comparator 408, a layer weight determiner 410 and an image comparator 412.

Data storage 404 is coupled with each module (i.e., each component) of processing system. Specifically, data storage 404 is coupled with each of network executer 406, descriptor comparator 408, layer weight determiner 410 and with image comparator 412 for enabling the different modules of system 400 to store and retrieve data. It is noted that all components of processing system 402 can be embedded on a single processing device or on an array of processing devices connected there-between. For example, components 406-412 are all embedded on a single graphics processing unit (GPU) 402, or a single Central Processing Unit (CPU) 402. Data storage 404 can be any storage device, such as a magnetic storage device (e.g., Hard Disc Drive—HDD), an optic storage device, and the like.

System 400 determines the weights of descriptor similarities of various image descriptors by performing the method steps of FIG. 2. Network executer 406 retrieves a trained network (e.g., a convolutional neural network) from data storage 404. Network executer 406 further retrieves a weight-assigning set of image from data storage 404. The similarity score between pairs of images of the weight-assigning set is known, or is predetermined. Network executer 406 applies the network on the images of the weight-assigning set, and records the output of each layer. Thereby, network executer 406 associates each image with a set of descriptors.

Descriptor comparator 408 retrieves a pair of images of the weight-assigning set, and retrieves the set of descriptors of each image of the pair. Descriptor comparator 408 determines the similarity between each pair of respective descriptors (i.e., descriptors of the pair of images produced by the same layer). Descriptor comparator 408 defines equation [1] for each pair of images:

α₁S₁+α₂S₂+ . . . +αₖSₖ=imageSimilarityScore [1]

Where S₁ is the determined similarity between the descriptors produced by the first layer (Dⁱ₁ and D^{j}₁), S₂ is the determined similarity between the descriptors produced by the second layer (Dⁱ₂ and D^{j}₂), and so forth. α₁ is the weight to be assigned (i.e., a variable) to the descriptor similarity between descriptors Dⁱ₁ and D^{j}₁ (S₁).

Layer weight determiner 410 retrieves the plurality of equations [1] defined by descriptor comparator 408 for the pairs of images of the weight-assigning set. Layer weight determiner 410 determines, for example by regression, the weight of each layer of the network.

After determining the weights of each descriptor similarity (i.e., the weight of each layer of the network, and more generally each image descriptor), system 400 determines image similarity between a pair of images by performing the method steps of FIG. 2. Network executer 406 retrieves a query image and a reference image from data storage 404. Network executer 406 applies the network on the query image and on the reference image and records the output of each layer. Thereby, network executer 406 associates each of the query image and the reference image with a set of descriptors defined by the output of the layers of the applied network. It is noted that at least one of the query image and reference image may have been previously fed into the network, and thereby may be already associated with the set of image descriptors.

Descriptor comparator 408 determines a descriptor similarity for each pair of respective descriptors. That is, Descriptor comparator 408 determines the descriptor similarity between the first image descriptor of the query image and the first image descriptor of the reference image, and so forth.

Image comparator 412, assigns the respective weight (as determined by layer weight determiner 410) to each of the determined descriptor similarities. Thereafter, image comparator 412 defines the image similarity between the query image and the reference image as a function of the weighted descriptor similarities. System 400 employs the determined image similarity between the query image and the reference image for performing various visual tasks, such as image retrieval or machine vision.

It is noted that system 400, operated in according to any one of the embodiments described in this application, provides an efficient manner for assigning weights to a set of image descriptors, and accordingly for determining image similarity. System 400 (and of the methods of the various embodiments herein) are efficient both in terms of computational resources, and in terms of similarity determination (i.e., showing good results).

In the examples set forth herein above with reference to FIGS. 1A, 1B, 2, 3 and 4, the methods and systems of the disclosed technique were exemplified by employing a CNN. However, the disclosed technique is not limited to CNNs only, and is applicable to other artificial neural networks as well. Moreover, the systems and methods of the disclosed technique can be applied for determining weights for any set of image descriptors (even if not produced by networks). Thereby, the systems and methods of the disclosed technique can be employed for determining image similarity by fusing weighted descriptor similarities for any set of image descriptors.

It will be appreciated by persons skilled in the art that the disclosed technique is not limited to what has been particularly shown and described hereinabove. Rather the scope of the disclosed technique is defined only by the claims, which follow.

1. A method for determining image similarity as a function of weighted descriptor similarities, the method comprising the procedures of:
feeding a query image to a network comprising a plurality of layers and defining an output of each of said layers as a descriptor of said query image;
feeding a reference image to said network and defining an output of each of said layers as a descriptor of said reference image;
determining a descriptor similarity score for respective descriptors that were produced by the same layer of said network fed said query image and said reference image;
assigning a respective weight to each descriptor similarity score; and
defining an image similarity between said query image and said reference image as a function of said weighted descriptor similarity scores.

2. The method of claim 1, wherein each descriptor includes a plurality of descriptor elements, and wherein each descriptor similarity score is a set of element similarity scores determined for respective descriptor elements.

3. The method of claim 2, wherein for a descriptor produced at the output of a convolutional layer of said network, each of said plurality of descriptor elements is produced by a filter of said convolutional layer, and wherein each of said set of element similarities being a similarity between an output of said filter for said query image and an output of said filter for said reference image.

4. The method of claim 1, wherein more than a single network is fed said query image and said reference image for producing descriptors.

5. The method of claim 1, further comprising a pre-procedure of determining said respective weight assigned to each descriptor similarity score according to a weight-assigning set of images.

6. The method of claim 5, wherein said pre-procedure of determining said respective weight assigned to each descriptor similarity score comprises the sub-procedures of:
receiving said weight-assigning set of images, wherein a similarity score for images of said weight-assigning set is known;
feeding images of said weight-assigning set to said network;
associating each image of said weight-assigning set with a set of descriptors produced at an output of each layer of said network when feeding said image to said network;
for a pair of images of said weight-assigning set, determining a descriptor similarity score for descriptors produced by the same layer; and
assigning a weight to each descriptor similarity score according to image similarity between pairs of images of said weight-assigning set, and according to descriptor similarity scores for descriptors of images of each of said pairs of images of said weight-assigning set.

7. The method of claim 1, wherein said respective weight assigned to each descriptor similarity score is the same for every query image.

8. The method of claim 1, wherein said respective weight is assigned to each descriptor similarity score according to a characteristic of said query image.

9. A method for determining image similarity as function of weighted descriptor similarities, the method comprising the following procedures:
defining a plurality of descriptors for a query image, and defining said plurality of descriptors for a reference image;
determining for each selected descriptor of said plurality of descriptors a descriptor similarity score for said selected descriptor of said query image and said selected descriptor of said reference image;
assigning a weight to each descriptor similarity score; and
defining an image similarity between said query image and said reference image as a function of weighted descriptor similarity scores.
